(19) United States
(12) Patent Application Publication
(10) Pub. No.: US 2003/0120759 A1
(43) Pub. Date: Jun. 26, 2003

(54) Interconnecting device, communication setting method and program thereof

(75) Inventor: Toshiya Ogawa, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(73) Assignee: ALLIED TELESIS K.K., Tokyo (JP)

(21) Appl. No.: 10/063,374

(22) Filed: Apr. 17, 2002

(30) Foreign Application Priority Data
Dec. 25, 2001 (JP) JP 2001-392445

(51) Int. Cl. G06F 15/173

(52) U.S. Cl. 709/221; 709/242

(57) ABSTRACT

An interconnecting device with at least one connection port for interconnecting communication in a computer network having one or more communication devices, including a management apparatus for managing the interconnecting device. A setting unit performs setting for the interconnecting device related to communication via the connection port. A processing unit of the interconnecting device determines, in a case where the setting unit registers one of the network communication devices for communication via the connection port, whether or not communication device identifying information stored in a first memory unit of the interconnecting device, for a communication device performing communication via the connection port, is identical to management apparatus identifying information for the management apparatus stored in a second memory unit of the interconnecting device. In a case where the communication device identifying information is determined to be identical to the management apparatus identifying information, a transmit unit transmits setting information regarding a communication setting by the setting unit to the management apparatus. The interconnecting device of the present invention prevents incorrect communication setting which stops communication with the management apparatus.

### CROSS REFERENCE TO RELATED APPLICATIONS

This patent application claims priority from a Japanese patent application No. 2001-392445 filed on Dec. 25, 2001, the contents of which are incorporated herein by reference.

### BACKGROUND OF THE INVENTION

1. Field of the Invention

The present invention relates to an interconnecting device, a communication setting method and a program thereof stored in a computer-readable medium. More particularly, the present invention relates to an interconnecting device that prevents communication breakdown with a management apparatus by performing communication setting after notifying the management apparatus.

2. Description of the Related Art

An interconnecting device such as a switching hub interconnects communication in a computer network. The interconnecting device performs various settings related to the communication, such as stopping communication via each of a plurality of connection ports of the interconnecting device, based on an instruction from the management apparatus that manages the communication settings in the interconnecting device. The management apparatus, however, cannot communicate with the interconnecting device after it sets the interconnecting device to stop communication via the connection port to which the management apparatus is connected, i.e., communication between the management apparatus and the interconnecting device breaks down. Therefore, it is preferable that the interconnecting device prevent the stop of communication via the connection port to which the management apparatus is connected.

Japanese Patent Application Laying-Open No. 9-130385 discloses that, in a case where the communication stop request was received for a certain connection port, it is determined whether or not the management apparatus is connected to that connection port based on a source address of the communication stop request packets. When the management apparatus is determined to be connected to the subject connection port, the interconnecting device does not execute the communication stop request for that connection port in response to the communication stop request.

The interconnecting device disclosed in the aforementioned Japanese patent application, however, has a problem in that it cannot set the interconnecting device to stop communication via the connection port to which the management apparatus is connected even if the communication via that connection port is to be stopped. The prior art interconnecting device does not perform a communication setting that stops communication via a connection port to which the management apparatus is connected.

### SUMMARY OF THE INVENTION

Therefore, it is an object of the present invention to provide an interconnecting device, a communication setting method and a program, which are capable of overcoming the above drawbacks accompanying the conventional art. The above and other objects can be achieved by combinations described in the independent claims. The dependent claims define further advantageous and exemplary combinations of the present invention.

According to a first aspect of the present invention, an interconnecting device that interconnects communication in a computer network including one or more communication devices, the one or more communication devices including a management apparatus that manages the interconnecting device, comprises: a first memory unit operable to store communication device identifying information for identifying a communication device performing communication via a connection port of the interconnecting device; a second memory unit operable to store management apparatus identifying information for identifying the management apparatus; a setting unit operable to perform communication setting for the interconnecting device, the setting being related to the one or more communication devices communicating via the connection port; a processing unit operable to determine, in a case where the setting unit performs the setting related to one of the communication devices for communication via the connection port, whether or not the communication device identifying information stored in the first memory unit matches with the management apparatus identifying information stored in the second memory unit; and a transmit unit operable to transmit setting information regarding the setting to the apparatus when the communication device identifying information is determined to match with the management apparatus identifying information.

The transmit unit may transmit SNMP trap as the setting information to the management apparatus when the processing unit determines that the communication device identifying information matched with the management apparatus identifying information.

The interconnecting device may further comprise a receive unit operable to receive approval information indicating that a setting change performed by the setting unit is approved by the management apparatus which received the setting information, wherein the setting unit registers a communication device for communication via the connection port in a case where the receive unit received the approval information.

The setting unit may perform the registration in a case where the receive unit received the approval information within a predetermined time period after the transmit unit transmitted the setting information.

The setting related to the communication via the connection port includes a communication stop request setting for the communication; the processing unit may determine, in a case where the setting unit performs the communication stop setting for the communication via the connection port, whether or not the communication device identifying information stored in the first memory unit matches with the management apparatus identifying information stored in the second memory unit, and the transmit unit may transmit communication stop information, indicating the communication via the connection port between the management apparatus and the interconnecting device is to be stopped, as the setting information to the management apparatus in a case where the processing unit determined that the communication device identifying information matches with the management apparatus identifying information.

The interconnecting device may further comprise a receive unit operable to receive approval information indicating that the stop of the communication between the management apparatus and the interconnecting device is approved by the management apparatus which received the communication stop information, wherein the setting unit performs the stop of the communication via the connection port in a case where the receive unit received the approval information.

The transmit unit may further transmit information indicating a further connection port for communication by the management apparatus after the stop of the communication via the connection port.

The setting unit may perform setting related to a VLAN associated with the connection port; the processing unit may determine, in a case where the setting unit performs the setting related to the VLAN, whether or not the communication device identifying information stored in the first memory unit matches with the management apparatus identifying information stored in the second memory unit, and the transmit unit may transmit VLAN information, indicating details of the setting related to the VLAN, as the setting information to the management apparatus in a case where the processing unit determined the communication device identifying information matches with the management apparatus identifying information.

The interconnecting device may further comprise a receive unit operable to receive approval information indicating a setting change in accordance with the VLAN information is approved by the management apparatus which received the VLAN information, wherein the setting unit performs the setting related to the VLAN associated with the connection port in a case where the receive unit received the approval information.

According to a second aspect of the present invention, a communication setting method for an interconnecting device that interconnects communication in a computer network including one or more communication devices, the one or more communication devices including a management apparatus that manages the interconnecting device, the method comprises: storing communication device identifying information for identifying a communication device performing communication via a connection port of the interconnecting device; storing management apparatus identifying information for identifying the management apparatus; receiving a communication setting request related to the one or more communication devices communicating via the connection port; in a case where the communication setting request was received, determining whether or not the communication device identifying information matches with the management apparatus identifying information; and transmitting setting information regarding the communication setting request to the management apparatus in a case where the communication device identifying information is determined to match with the management apparatus identifying information.

The communication setting method may further comprise: receiving, from the management apparatus, approval information that indicates a setting change in accordance with the communication setting request is approved; and registering a communication device for communication via the connection port in accordance with the communication setting request in a case where the approval information was received.

According to a third aspect of the present invention, a program stored in a computer-readable medium for use with an interconnecting device that interconnects communication in a computer network including one or more communication devices, the one or more communication devices including a management apparatus that manages the interconnecting device, the program comprises: a first storing module operable to instruct a first memory unit of the interconnecting device to store communication device identifying information for identifying a communication device performing communication via a connection port of the interconnecting device; a second storing module operable to instruct a second memory unit of the interconnecting device to store management apparatus identifying information for identifying the management apparatus; a setting module operable to perform communication setting of the interconnecting device related to the one or more communication devices communicating via the connection port; a determining module operable to determine, in a case where the setting module performs the setting related to one of the communication devices for communication via the connection port, whether or not the communication device identifying information matches with the management apparatus identifying information; and a transmitting module operable to cause the interconnecting unit to transmit setting information, regarding the setting by the setting module, to the management apparatus in a case where the communication device identifying information matches with the management apparatus identifying information.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF DRAWINGS

FIG. 1 illustrates an exemplary structure of a computer network according to an embodiment of the present invention.

FIG. 2 illustrates an exemplary structure of an interconnecting device in the computer network shown in FIG. 1.

FIG. 3 shows an example of data stored in the first and second memory units of the interconnecting device in FIG. 2.

FIG. 4 illustrates an exemplary VLAN configuration associated with the interconnecting device in FIG. 2.

FIG. 5 shows a sequence of communication between a management apparatus and an interconnecting device according to an embodiment of the present invention.

FIG. 6 illustrates an exemplary hardware configuration of a management apparatus according to an embodiment of the present invention.

### DETAILED DESCRIPTION

The invention will now be described based on the preferred embodiments, which do not intend to limit the scope of the present invention, but exemplify the invention. All of the features and the combinations thereof described in the embodiments are not necessarily essential to the invention.

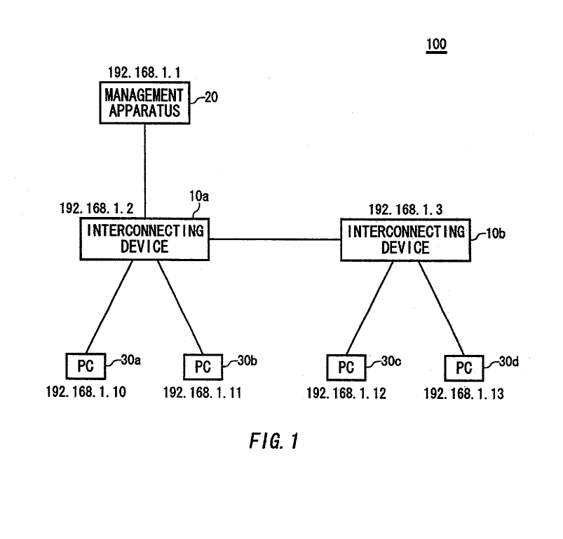

FIG. 1 illustrates an exemplary structure of a computer network 100 according to an embodiment of the present invention. The computer network 100 includes interconnecting devices 10a and 10b that interconnect communication through the computer network 100, a management apparatus 20 that manages the communication in the computer network 100, and personal computers (PCs) 30a, 30b, 30c and 30d that perform communication in the computer network 100. The interconnecting devices 10a and 10b, the management apparatus 20 and the PCs 30a, 30b, 30c and 30d are examples of communication devices. The interconnecting devices 10a and 10b may be a hub, a switch, a router or a gateway.

For purposes of explanation, in the present embodiment, the IP address of the management apparatus 20 is “192.168.1.1”, the IP address of the interconnecting device 10a is “192.168.1.2”, the IP address of the interconnecting device 10b is “192.168.1.3”, the IP address of the PC 30a is “192.168.1.10”, the IP address of the PC 30b is “192.168.1.11”, the IP address of the PC 30c is “192.168.1.12” and the IP address of the PC 30d is “192.168.1.13”.

The management apparatus 20 performs the various settings related to the communication in the computer network 100 based on an instruction from the administrator of the computer network 100. More specifically, the management apparatus 20 sets the stop and start of the communication via the connection ports of the interconnecting device 10a or 10b. Moreover, the management apparatus 20 performs setting related to a VLAN associated with the interconnecting device 10a or 10b. In this way, the management apparatus 20 manages the communication between the PCs 30a, 30b, 30c and 30d in the computer network 100. For example, the management apparatus 20 may perform a setting related to the communication for the interconnecting device 10a or 10b by using “SET REQUEST” or “GET REQUEST” of SNMP (Simple Network Management Protocol). Moreover, the management apparatus 20 may perform the setting related to the communication for the interconnecting device 10a or 10b after logging in the interconnecting device 10a or 10b via telnet.

The interconnecting devices 10a and 10b perform settings related to the communication thereof based on the instruction from the management apparatus 20. More specifically, the interconnecting devices 10a and 10b set the communication of a connection port to stop or start in accordance with the communication stop request or communication start request for that connection port from the management apparatus 20. Each of the interconnecting devices 10a and 10b also performs thereof the setting related to the associated VLAN.

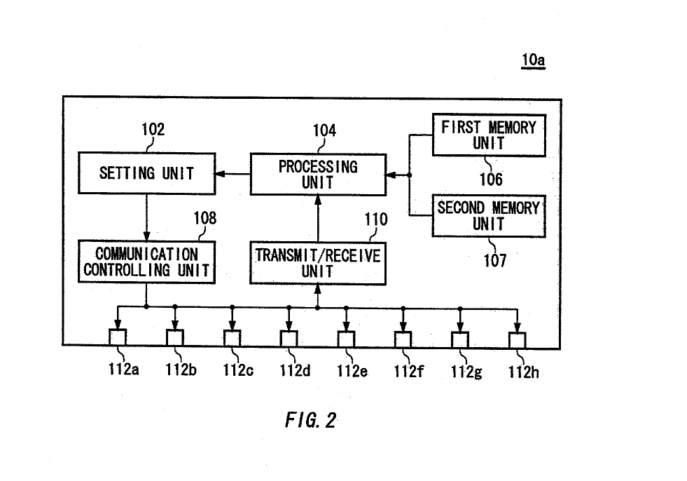

FIG. 2 illustrates an exemplary structure of the interconnecting device 10a according to the present embodiment. The interconnecting devices 10a and 10b have the same structure and therefore only the structure and operation of the interconnecting device 10a are described as a typical example.

The interconnecting device 10a includes connection ports 112a to 112h to which communication devices are connected, a transmit/receive unit 110 that transmits and receives data via the connection ports 112a to 112h, a communication controlling unit 108 that controls the communication via the connection ports 112a to 112h, a setting unit 102 that registers the communication devices that communicate via the connection ports 112a to 112h, a first memory unit 106 that stores communication device identifying information for identifying the communication device performing communication via each of the connection ports 112a to 112h, a second memory unit 107 that stores management apparatus identifying information for identifying the management apparatus 20, and a processing unit 104 that determines the connection port to which the management apparatus 20 is connected based on the communication device identifying information and the management apparatus identifying information stored in the first and second memory units 106 and 107, respectively.

The transmit/receive unit 110 transmits/receives data to/from the management apparatus 20, the interconnecting device 10b and the PCs 30a, 30b, 30c and 30d, and interconnects the communication between the management apparatus 20, the interconnecting device 10b, and the PCs 30a, 30b, 30c and 30d. The transmit/receive unit 110 also receives setting information regarding the setting of the interconnecting device 10a, that is, information regarding the setting in the communication controlling unit 108, from the management apparatus 20. More specifically, the transmit/receive unit 110 receives the communication stop request, the communication start request and the VLAN set request for each connection port as the setting information from the management apparatus 20. In addition, the transmit/receive unit 110 transmits setting information of the interconnecting device 10a, i.e., the information regarding the setting in the communication controlling unit 108, to the management apparatus 20. More specifically, the transmit/receive unit 110 transmits information indicating the communication status of the respective connection ports or information describing the associated VLAN structure for the respective connection ports as the setting information of the interconnecting device 10a to the management apparatus 20.

The first memory unit 106 stores, as the communication device identifying information for each communication device, IP address and MAC address of the communication device in such a manner that the addresses of each communication device correspond to an associated one of the connection ports 112a to 112h to which that communication device is connected. More specifically, the first memory unit 106 stores a destination IP address of the packet the transmit/receive unit 110 received and a MAC address obtained in accordance with ARP (Address Resolution Protocol) based on this destination IP address. The first memory unit 106 also stores a source IP address of the packet the transmit/receive unit 106 received and a corresponding MAC address obtained in accordance with ARP based on this source IP address. The second memory unit 107 stores the IP address of the management apparatus 20 that was input by the administrator of the computer network 100 as the management apparatus identifying information.

In a case where the transmit/receive unit 110 received the communication stop request or the VLAN setting request for one of the connection ports 112a to 112h, the processing unit 104 determines whether or not the management apparatus 20 is connected to the requested connection port. More specifically, the processing unit 104 determines whether or not the IP address stored in the first memory unit 106 to correspond to the connection port for which the communication stop request or VLAN set request was received matches with the IP address of the management apparatus 20 stored in the second memory unit 107, thereby determining whether or not the management apparatus 20 is connected to that connection port.

The setting unit 102 performs the setting regarding the communication in the communication controlling unit 108 based on the setting information that the receive/transmit unit 110 received from the management apparatus 20. For example, the setting unit 102 performs the setting related to the communication in the communication controlling unit 108 in accordance with the communication stop request, communication start request or VLAN set request for the respective connection ports received by the transmit/receive unit 110. The communication controlling unit 108 controls the communication via the respective connection ports 112a to 112h based on the setting related to the communication performed by the setting unit 102.

In a case where the transmit/receive unit 110 received the communication stop request for a certain connection port and the processing unit 104 determined that the management apparatus 20 was connected to that connection port, the transmit/receive unit 110 transmits, to the management apparatus 20, communication stop information indicating that the communication between the interconnecting device 10a and the management apparatus 20 is to be stopped. For example, the transmit/receive unit 110 transmits SNMP trap as the communication stop information. Then, in a case where the transmit/receive unit 110 receives, from the management apparatus 20 that had received the communication stop information, approval information indicating that the stop of the communication between the management apparatus 20 and the interconnecting device 10a was approved, the setting unit 102 sets the communication via the connection port for which the communication stop request was received by the transmit/receive unit 110 to be stopped in response to the communication stop request received by the transmit/receive unit 110. Moreover, the transmit/receive unit 110 may transmit to the management apparatus 20 information indicating another connection port via which the management apparatus 20 can communicate with the interconnecting device 10a.

In a case where the transmit/receive unit 110 received the VLAN set request and the processing unit 104 determined that the management apparatus 20 was connected to the connection port for which the VLAN set request was received, the transmit/receive unit 110 transmits to the management apparatus 20 VLAN information describing the details of the VLAN set request. Then, in a case where the transmit/receive unit 110 receives, from the management apparatus 20 that had received the VLAN information, the approval information for approving the change to the present VLAN setting, the setting unit 102 performs the setting regarding the VLAN for the connection port for which the VLAN set request was received in accordance with the received VLAN set request.

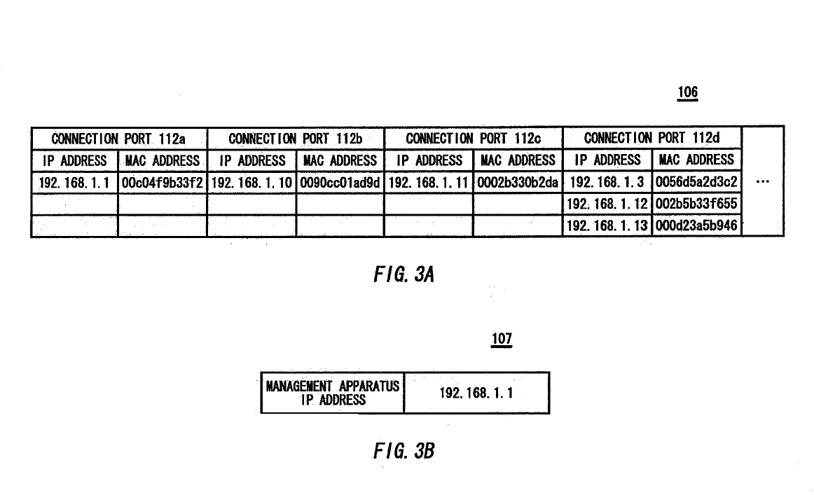

FIGS. 3A and 3B show exemplary data stored in the first and second memory units 106 and 107 according to the present embodiment. FIG. 3A shows a connection port management table stored in the first memory unit 106. As shown in FIG. 3A, the connection port management table stores, for each of the connection ports 112a to 112h, the IP address and MAC address of each of the associated communication devices that perform communication via that connection port. In other words, the IP and MAC addresses of the communication device(s) are stored to correspond to the associated connection port.

More specifically, the IP address and MAC address of the management apparatus 20, “192.168.1.1” and “00c04f9b33f2”, are stored to correspond to the connection port 112a, as shown in FIG. 3A. This indicates the management apparatus 20 performs communication via the connection port 112a. As for the connection port 112b, the IP address and MAC address of the PC 30a, “192.168.1.10” and “0090cc01ad9d”, are stored to correspond to the connection port 112b, indicating the PC 30a performs communication via the connection port 112b. As for the connection port 112c, the IP address and MAC address of the PC 30b, “192.168.1.11” and “0002b330b2da”, are stored. This indicates the PC 30b performs communication via the connection port 112c. As for the connection port 112d, the IP address and MAC address of the interconnecting device 10b, “192.168.1.3” and “0056d5a2d3c2”, the IP address and MAC address of the PC 30c, “192.168.1.12” and “002b5b33f655”, and the IP address and MAC address of the PC 30d, “192.168.1.13” and “000d23a5b946”, are stored. This indicates the interconnecting device 10b and the PCs 30c and 30d perform communication via the connection port 112d.

FIG. 3B shows a management apparatus IP address table stored in the second memory unit 107. As shown in FIG. 3B, the management apparatus IP address table stores the IP address of the management apparatus 20.

Referring to FIGS. 3A and 3B, the operation of the interconnecting device 10a, in a case where the transmit/receive unit 110 received the communication stop request for a connection port, is described. In the case where the transmit/receive unit 110 received the communication stop request for the connection port 112a, the processing unit 104 compares the IP address in the management apparatus IP address table (see FIG. 3B) stored in the second memory unit 107 with the IP address in the connection port management table (see FIG. 3A) stored in the first memory unit 106, that is stored to correspond to the connection port 112a. The processing unit 104 then determines that the management apparatus 20 is connected to the connection port 112a. In this case, the processing unit 104 instructs the transmit/receive unit 110 to accept the communication stop request for the connection port 112a so as to transmit to the management apparatus 20 the communication stop information indicating that the communication between the management apparatus 20 and the interconnecting device 10a is to be stopped. The transmit/receive unit 110 then transmits the communication stop information to the management apparatus 20 in response to the instruction from the processing unit 104. In a case where various requests regarding the communication setting use SNMP, the transmit/receive unit 110 transmits SNMP trap as the communication stop information. In another case where various requests regarding the communication setting use telnet, the transmit/receive unit 110 causes the management apparatus 20, for example, to display the communication stop information on a console display thereof.

Next, the operation of the interconnecting device 10a in a case where the transmit/receive unit 110 received the communication stop request for the connection port 112d is described, referring to FIGS. 3A and 3B. When the transmit/receive unit 110 received the communication stop request for the connection port 112d, the processing unit 104 compares the IP address in the management apparatus IP address table (see FIG. 3B), stored in the second memory unit 107, with each IP address sequentially in the connection port management table (see FIG. 3A), stored in the first memory unit 106, corresponding to the connection port 112d. The processing unit 104 then determines that the management apparatus 20 is not connected to the connection port 112d. In this case, the processing unit 104 instructs the setting unit 102 to perform setting in the communication controlling unit 108 in accordance with the communication stop request for the connection port received by the transmit/receive unit 110. The setting unit 102 then sets the communication controlling unit 108 to stop the communication via the connection port 112d in response to the instruction from the processing unit 104.

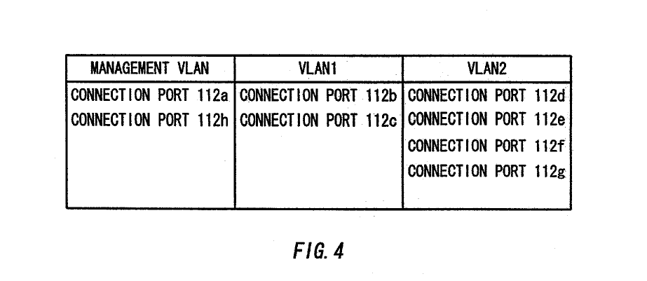

FIG. 4 shows an exemplary VLAN structure associated with the interconnecting device 10a according to the present embodiment. As shown in FIG. 4, for the interconnecting device 10a, a management VLAN and VLANs 1 and 2 are formed by a port-based VLAN. The connection ports 112a and 112h are associated with the management VLAN, and the management apparatus 20 can perform communication the management VLAN. The management VLAN is the VLAN through which the setting related to the communication for the interconnecting device 10a is allowed. Communication devices that are not included in the management VLAN cannot perform the communication setting of the interconnecting device 10a.

VLAN 1 is formed by the connection ports 112b and 112c, and therefore the PCs 30a and 30b can perform the communication in VLAN 1. Moreover, VLAN 2 is formed by the connection ports 112d, 112e, 112f and 112g and therefore the interconnecting device 10b and the PCs 30c and 30d can perform the communication in VLAN 2.

Referring to FIGS. 3A, 3B and 4, the operation of the interconnecting device 10a in a case where the transmit/receive unit 110 received the VLAN set request that requested transfer of the connection port 112a to VLAN 1 is described. When the transmit/receive unit 110 received the VLAN set request requesting the transfer of the connection port 112a to VLAN 1, the processing unit 104 compares the IP address in the management apparatus IP address table (see FIG. 3B), stored in the second memory unit 107, with the IP address in the connection port management table (see FIG. 3A), stored in the first memory unit 106, that is stored to correspond to the connection port 112a. The processing unit 104 then determines that the management apparatus 20 is connected to the connection port 112a. In this case, the processing unit 104 instructs the transmit/receive unit 110 to transmit to the management apparatus 20 the VLAN information, with details of the VLAN set request indicating that the communication between the management apparatus 20 and the interconnecting device 10a is to be changed, by accepting the VLAN set request received by the transmit/receive unit 110. The transmit/receive unit 110 transmits the VLAN information to the management apparatus 20 based on the instruction from the processing unit 104.

Moreover, referring to FIGS. 3A, 3B and 4, the operation of the interconnecting device 10a in a case where the transmit/receive unit 110 received a VLAN set request that requested transfer of the connection port 112h to VLAN 1 is described. When the transmit/receive unit 110 received the VLAN set request requesting the transfer of the connection port 112h to VLAN 1, the processing unit 104 compares the IP address in the management apparatus IP address table (see FIG. 3B), stored in the second memory unit 107, with each IP address sequentially in the connection port management table (see FIG. 3A), stored in the first memory unit 106, corresponding to the connection port 112h. The processing unit 104 then determines that the management apparatus 20 is not connected to the connection port 112h. In this case, the processing unit 104 instructs the setting unit 102 to set the communication controlling unit 108 in accordance with the VLAN set request received by the transmit/receive unit 110. The setting unit 102 then sets the communication controlling unit 108 to change the VLAN configuration based on the instruction from the processing unit 104.

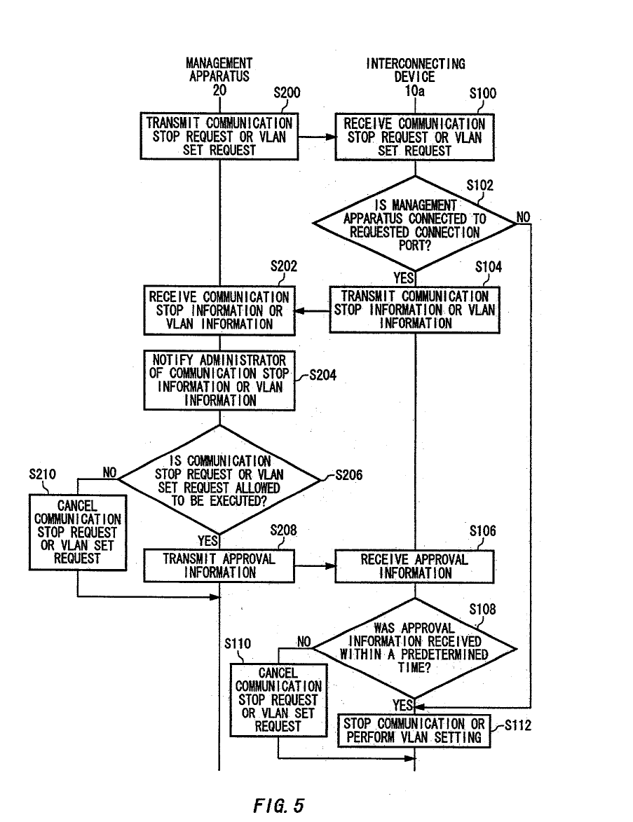

FIG. 5 shows an exemplary sequence of communication between the management apparatus 20 and the interconnecting device 10a according to the present embodiment. First, the management apparatus 20 transmits a communication stop request or VLAN set request for one of the connection ports 112a to 112h in accordance with an instruction from the administrator (Step S200).

Then, in the interconnecting device 10a, the transmit/receive unit 110 receives the communication stop request or the VLAN set request for one of the connection ports 112a to 112h from the management apparatus 20 (Step S100). The processing unit 104 then determines whether or not the management apparatus 20 is connected to the connection port for which the stop of the communication or the set of the VLAN was requested (Step S102). That is, the processing unit 104 determines whether or the connection port management table (FIG. 3A), in the first memory unit 106, stores the IP address of the management apparatus 20, which is in the management apparatus IP address table (FIG. 3B) stored in the second memory unit 107, in such a manner that the management apparatus IP address corresponds, in the connection port management table, to the connection port for which the communication stop or the set of the VLAN was requested. In a case where it is determined in Step S102 that the management apparatus 20 is not connected to the connection port for which the stop of the communication or the set of the VLAN was requested, the processing unit 104 instructs the setting unit 102 to set the communication controlling unit 108 based on the communication stop request or the VLAN set request received by the transmit/receive unit 110. The setting unit 102 then stops the communication via the connection port or performs the setting related to the VLAN for the connection port in accordance with the instruction from the processing unit 104 (Step S112).

In a case where it was determined in Step S102 that the management apparatus 20 is connected to the connection port for which the stop of the communication or set of the VLAN was requested, the transmit/receive unit 110 transmits to the management apparatus 20 the appropriate information, i.e., communication stop information and/or VLAN information, indicating that communication between the management apparatus 20 and the interconnecting device 10a is to be stopped and/or changed in accordance with the received request (Step S104). The management apparatus 20 then receives the transmitted notification information (Step S202), and thereafter notifies the administrator of the information by a sound indication, for example (Step S204). The administrator confirms the information and then determines whether or not the communication stop request or the VLAN set request for that connection port should be allowed to be executed (Step S206). When it is determined in Step S206 that the communication stop request or the VLAN set request is not to be executed, the management apparatus 20 cancels the stop of the communication or the set of the VLAN and does not respond to the notification information transmitted in Step S104 (Step S210).

When it was determined in Step S206 that the communication stop request or the VLAN set request is to be executed, the management apparatus 20 transmits to the interconnecting device 10a approval information that approves the stop of the communication or the details of the change to the VLAN setting (Step S208). The management apparatus 20 may transmit again the communication stop request or the VLAN set request, transmitted in Step S200, as the approval information.

Then, in the interconnecting device 110a, the transmit/receive unit 110 receives the approval information that approves the stop of the communication or the details of the change to the VLAN setting from the management apparatus 20 (Step S106). The processing unit 104 then determines whether or not the transmit/receive unit 110 received the approval information within a time period after the transmit/receive unit 110 transmitted the notification information in Step S104 (Step S108). In a case where it is determined in Step S108 that the approval information was not received within the predetermined time period, the processing unit 104 cancels the communication stop request, the stop of the communication in accordance with the VLAN set request or the setting of the VLAN, so that it does not change the setting related to the communication (Step S110). In a case where it is determined in Step S108 that the approval information was received within the predetermined time period, the processing unit 104 instructs the setting unit 102 to set the communication controlling unit 108 based on the communication stop request or the VLAN set request received by the transmit/receive unit 110. The setting unit 102 then stops communication via the connection port for which the stop of the communication was requested or performs the setting related to the VLAN for that connection port based on the instruction from the processing unit 104 (Step S112).

According to the interconnecting device 10a of the present embodiment, in a case where the interconnecting device 10a received a request for stopping communication via the connection port to which the management apparatus 20 is connected or a VLAN setting request that requests transfer of the management apparatus 20 from the management VLAN, the interconnecting device 10a transmits information to the management apparatus 20 indicating that the management apparatus 20 cannot perform further communication settings for the interconnecting device 10a after the transmission of this information. Therefore, an administrator of the network 100 can confirm whether or not to stop communication via the referenced connection port or the details of the VLAN setting by a notification from the management apparatus 20 the interconnecting device 10a. Therefore, it is possible to prevent a situation where the management apparatus 20 cannot perform setting for the interconnecting device 10a related to the communication thereof because of the stop of communication between the management apparatus 20 and the interconnecting device 10a or setting of the VLAN.

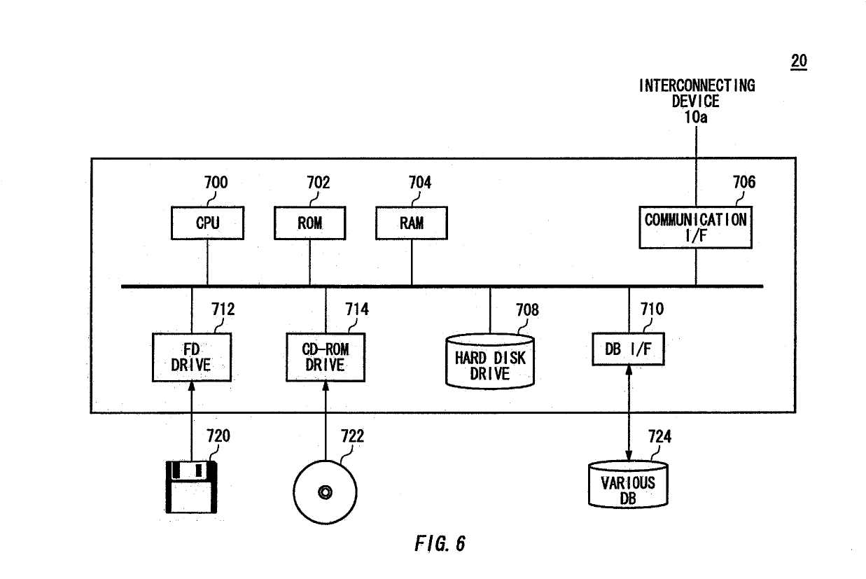

FIG. 6 illustrates an exemplary hardware configuration of the management apparatus 20 according to an embodiment of the present invention. The management apparatus 20 includes a CPU 700, a ROM 702, a RAM 704, a communication interface 706, a hard disk drive 708, a database interface 710, a floppy disk drive 712 and a CD-ROM drive 714. The CPU 700 operates based on at least one program stored in the ROM 702 and RAM 704. The communication interface 706 communicates with the interconnecting device 10a through the computer network 100. The database interface 710 writes data into a database and updates the contents of the database.

The floppy disk drive 712 reads data or program from a floppy disk 720 to provide the read data or program to the CPU 700. The CD-ROM drive 714 reads data or program from a CD-ROM 722 to provide the read data or program to the CPU 700. The communication interface 706 transmits the data or program provided by the floppy disk drive 712 or CD-ROM drive 714 to the interconnecting device 10a. The database interface 710 can be connected to various types of database 724 to perform data transmission and data receiving therewith.

The program provided to the interconnecting device 10a is provided by a user while being stored in a recording medium such as the floppy disk 720 or the CD-ROM 722. The program stored in the recording medium may be compressed or not-compressed. The program is read from the recording medium to be installed into the interconnecting device 10a via the communication interface 706, so that the interconnecting device 10a executes the program.

The program provided while being stored in the recording medium, that is the program to be installed into the interconnecting device 10a, functionally includes a setting module, a determining module, a storing module, a communication controlling module and a transmit/receive module. Operations that are to be executed by the interconnection device 10a in accordance with instructions of the respective modules are the same as the functions and operations of the corresponding components in the interconnecting device 10a described herein referring to FIGS. 1-5, and therefore the description thereof is omitted.

A part or all of the functions and operations of the interconnecting device 10a according to all the embodiments described herein can be stored in the floppy disk 720 or the CD-ROM 722 as an example of the recording medium.

These programs may be read directly into the RAM from the recording medium, or read into the RAM after being installed into the hard disk drive from the recording medium. Moreover, the above-mentioned program may be stored in a single recording medium or a plurality of recording media. Furthermore, the program may be stored while being encoded, for example, by encryption or compression.

As the recording medium, other than the floppy disk and the CD-ROM, an optical recording medium such as a DVD or a PD, a magneto-optical recording medium such as an MD, a tape-like medium, a magnetic recording medium, or a semiconductor memory such as an IC card or a miniature card can be used. Moreover, a storage device such as a hard disk or a RAM provided in a server system connected to an exclusive communication network or the Internet may be used as the recording medium, so that the program can be provided to the interconnecting device 10a through a communication network.

As is apparent from the above, according to the present invention, an interconnecting device can be provided that can prevent an improper or unexpected stop of communication with a management apparatus that manages the interconnecting device so that control by the management apparatus of communication setting of the interconnecting device is not lost.

Although the present invention has been described by way of exemplary embodiments, it should be understood that those skilled in the art might make many changes and substitutions without departing from the spirit and the scope of the present invention which is defined only by the appended claims.

1. An interconnecting device that interconnects communication in a computer network including one or more communication devices, said one or more communication devices including a management apparatus that manages the interconnecting device, the interconnecting device comprising:
a first memory unit operable to store communication device identifying information for identifying a communication device performing communication via a connection port of the interconnecting device;
a second memory unit operable to store management apparatus identifying information for identifying the management apparatus;
a setting unit operable to perform communication setting for said interconnecting device, said setting being related to said one or more communication devices communicating via said connection port;
a processing unit operable to determine, in a case where said setting unit performs said setting related to one of said communication devices for communication via said connection port, whether or not said communication device identifying information stored in said first memory unit matches with said management apparatus identifying information stored in said second memory unit; and
a transmit unit operable to transmit setting information regarding said setting to said management apparatus when said communication device identifying information is determined to match with said management apparatus identifying information.

2. An interconnecting device as claimed in claim 1, wherein said transmit unit transmits SNMP trap as said setting information to said management apparatus when said processing unit determines that said communication device identifying information matched with said management apparatus identifying information.

3. An interconnecting device as claimed in claim 1, further comprising a receive unit operable to receive approval information indicating that a setting change performed by said setting unit is approved by said management apparatus which received said setting information, wherein
said setting unit registers a communication device for communication via said connection port in a case where said receive unit received said approval information.

4. An interconnecting device as claimed in claim 3, wherein said setting unit performs said registration in a case where said receive unit received said approval information within a predetermined time period after said transmit unit transmitted said setting information.

5. An interconnecting device as claimed in claim 1, wherein said setting related to said communication via said connection port includes a communication stop request setting for said communication,
said processing unit determines, in a case where said setting unit performs said communication stop setting for said communication via said connection port, whether or not said communication device identifying information stored in said first memory unit matches with said management apparatus identifying information stored in said second memory unit, and
said transmit unit transmits communication stop information, indicating said communication via said connection port between said management apparatus and said interconnecting device is to be stopped, as said setting information to said management apparatus in a case where said processing unit determined that said communication device identifying information matches with said management apparatus identifying information.

6. An interconnecting device as claimed in claim 5, further comprising a receive unit operable to receive approval information indicating that said stop of said communication between said management apparatus and said interconnecting device is approved by said management apparatus which received said communication stop information, wherein
said setting unit performs said stop of said communication via said connection port in a case where said receive unit received said approval information.

7. An interconnecting device as claimed in claim 6, wherein said transmit unit further transmits information indicating a further connection port for communication by said management apparatus after said stop of said communication via said connection port.

8. An interconnecting device as claimed in claim 1, wherein said setting unit performs setting related to a VLAN associated with said connection port,
said processing unit determines, in a case where said setting unit performs said setting related to said VLAN, whether or not said communication device identifying information stored in said first memory unit matches with said management apparatus identifying information stored in said second memory unit, and
said transmit unit transmits VLAN information, indicating details of said setting related to said VLAN, as said setting information to said management apparatus in a case where said processing unit determined said communication device identifying information matches with said management apparatus identifying information.

9. An interconnecting device as claimed in claim 8, further comprising a receive unit operable to receive approval information indicating a setting change in accordance with said VLAN information is approved by said management apparatus which received said VLAN information, wherein
said setting unit performs said setting related to said VLAN associated with said connection port in a case where said receive unit received said approval information.

10. A communication setting method for an interconnecting device that interconnects communication in a computer network including one or more communication devices, said one or more communication devices including a management apparatus that manages the interconnecting device, the method comprising:
storing communication device identifying information for identifying a communication device performing communication via a connection port of the interconnecting device;
storing management apparatus identifying information for identifying the management apparatus;
receiving a communication setting request related to said one or more communication devices communicating via said connection port;
in a case where said communication setting request was received, determining whether or not said communication device identifying information matches with said management apparatus identifying information; and
transmitting setting information regarding said communication setting request to said management apparatus in a case where said communication device identifying information is determined to match with said management apparatus identifying information.

11. A communication setting method as claimed in claim 10, further comprising:
receiving, from said management apparatus, approval information that indicates a setting change in accordance with said communication setting request is approved; and
registering a communication device for communication via said connection port in accordance with said communication setting request in a case where said approval information was received.

12. A program stored in a computer-readable medium for use with an interconnecting device that interconnects communication in a computer network including one or more communication devices, said one or more communication devices including a management apparatus that manages the interconnecting device, the program comprising:
a first storing module operable to instruct a first memory unit of the interconnecting device to store communication device identifying information for identifying a communication device performing communication via a connection port of the interconnecting device;
a second storing module operable to instruct a second memory unit of the interconnecting device to store management apparatus identifying information for identifying the management apparatus;
a setting module operable to perform communication setting of the interconnecting device related to said one or more communication devices communicating via said connection port;
a determining module operable to determine, in a case where said setting module performs said setting related to one of said communication devices for communication via said connection port, whether or not said communication device identifying information matches with said management apparatus identifying information; and
a transmitting module operable to cause the interconnecting unit to transmit setting information, regarding said setting by said setting module, to the management apparatus in a case where said communication device identifying information matches with said management apparatus identifying information.
